(19) United States
(12) Patent Application Publication
(10) Pub. No.: US 2023/0249635 A1
(43) Pub. Date: Aug. 10, 2023

(54) VEHICULAR BACKUP DEVICE

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Junji TSUCHIYA, Yokkaichi-shi, Mie (JP); Takeshi HASEGAWA, Yokkaichi-shi, Mie (JP)

(21) Appl. No.: 18/004,815

(22) PCT Filed: Mar. 19, 2021
(86) PCT No.: PCT/JP2021/011364

§ 371 Date: Jan. 9, 2023

(30) Foreign Application Priority Data
Jul. 13, 2020 (JP) 2020-119747

(51) Int. Cl. B60R 16/033; H02J 7/00

(52) U.S. Cl. CPC B60R 16/033; H02J 7/007194

(57) ABSTRACT

Provided is a technology that is able to set the charge voltage of an auxiliary power source to reflect the temperature state during a period in which the vehicle is stopped. A vehicular backup device includes a charge/discharge circuit, a temperature detection unit, and a control unit. The control unit causes the charge/discharge circuit to perform an operation such that the charge voltage of an auxiliary power source achieves a target voltage on condition that a start switch of the vehicle is ON. The control unit sets the target voltage based on the temperature detected by the temperature detection unit when the start switch is OFF.

### CROSS-REFERENCE TO RELATED APPLICATIONS

This application is the U.S. national stage of PCT/JP2021/011364 filed on Mar. 19, 2021, which claims priority of Japanese Patent Application No. JP 2020-119747 filed on Jul. 13, 2020, the contents of which are incorporated herein.

### TECHNICAL FIELD

The present disclosure relates to a vehicular backup device.

### BACKGROUND

In vehicular power systems, if the main power source fails, power supply to the load is interrupted, and electrical operations (e.g., various electronic controls, etc.) are incapacitated. The technology of JP 2004-322987A addresses this problem by using, as an auxiliary power source, a capacitor unit that uses a plurality of electric double layer capacitors. The vehicular power device of JP 2004-322987A uses the capacitors as an auxiliary power source during vehicle operation by charging the capacitors after the start of vehicle operation to increase the charge voltage, and reduces the charge voltage by discharging the capacitors at the end of vehicle operation to suppress degradation of the capacitors.

However, in setting the charge voltage of the auxiliary power source, the technology of JP 2004-322987A does not take into account the degree of degradation from when vehicle operation is stopped until when the vehicle is next started.

One object of the present disclosure is to provide a technology that is able to set the charge voltage of an auxiliary power source to reflect the temperature state during a period in which the vehicle is stopped.

### SUMMARY

A vehicular backup device serving as one device of the present disclosure is a vehicular backup device for use in a vehicular power system that includes a main power source and an auxiliary power source that functions as a power supply source at least when power supply from the main power source is abnormal, and for controlling charging and discharging of the auxiliary power source. The backup device includes: a charge/discharge circuit configured to perform operations for charging and discharging the auxiliary power source; a temperature detection unit configured to detect a temperature of the auxiliary power source or around the auxiliary power source; and a control unit configured to cause the charge/discharge circuit to perform an operation such that a charge voltage of the auxiliary power source achieves a target voltage on condition that a start switch of a vehicle is ON, the control unit setting the target voltage based on the temperature detected by the temperature detection unit when the start switch is OFF.

### ADVANTAGEOUS EFFECTS OF INVENTION

A vehicular backup device serving as one device of the present disclosure is able to set the charge voltage of an auxiliary power source to reflect the temperature state during a period in which the vehicle is stopped.

### BRIEF DESCRIPTION OF DRAWINGS

FIG. 1 is a block diagram schematically illustrating a vehicular power system that includes a vehicular backup device of a first embodiment.

FIG. 2 is an illustrative diagram specifically illustrating mainly part of the vehicular power system of FIG. 1.

FIG. 3 is a flowchart illustrating the flow of control that is performed in the vehicle backup device of the first embodiment.

FIG. 4 is a flowchart illustrating the flow of control that is performed in the vehicle backup device of a third embodiment.

FIG. 5 is a flowchart illustrating the flow of temperature detection processing during the control shown in FIG. 4 in the third embodiment.

FIG. 6 is a flowchart illustrating the flow of temperature detection processing during the control shown in FIG. 4 in a fourth embodiment.

### DETAILED DESCRIPTION OF PREFERRED EMBODIMENTS

Hereinafter, embodiments of the present disclosure will be enumerated and described. Note that the features of [1] to [15] illustrated below may be freely combined as long as there are no inconsistencies.

### First Aspect

In accordance with a first aspect, a vehicular backup device for use in a vehicular power system that includes a main power source and an auxiliary power source that functions as a power supply source at least when power supply from the main power source is abnormal, and for controlling charging and discharging of the auxiliary power source. The backup device includes: a charge/discharge circuit configured to perform operations for charging and discharging the auxiliary power source; a temperature detection unit configured to detect a temperature of the auxiliary power source or around the auxiliary power source; and a control unit configured to cause the charge/discharge circuit to perform an operation such that a charge voltage of the auxiliary power source achieves a target voltage on condition that a start switch of a vehicle is ON, the control unit setting the target voltage based on the temperature detected by the temperature detection unit when the start switch is OFF.

The vehicular backup device of a first aspect is able to set the target voltage for when charging the auxiliary power source after starting vehicle operation, based on the temperature that is detected by the temperature detection unit when the start switch is OFF. Therefore, this vehicular backup device is able to set the charge voltage of the auxiliary power source to reflect the temperature state during the period in which the vehicle is stopped.

### Second Aspect

In a second aspect, the vehicular backup device according to the first aspect, the control unit sets the target voltage based on the temperature detected by the temperature detection unit after a given time period elapses while the start switch is maintained in the OFF state.

The vehicular backup device of the second aspect is able to set the target voltage to reflect the temperature of the auxiliary power source or around the auxiliary power source after a certain amount of time elapses after the start switch turns OFF.

### Third Aspect

In a third aspect, the vehicular backup device according to the first or second aspect, the control unit sets the target voltage based on the temperature detected by the temperature detection unit every predetermined time period when the start switch is maintained in the OFF state.

The vehicular backup device of the third aspect is able to set the target voltage to reflect the temperature of the auxiliary power source or around the auxiliary power source periodically detected while the vehicle is stopped. Therefore, the target voltage can be set to more strongly reflect the temperature environment that exists while the vehicle is stopped.

### Fourth Aspect

In a fourth aspect, the vehicular backup device according to any of the first to the third aspects, in a case where the temperature detection unit detects temperatures of a plurality of durations when the start switch is OFF, the control unit calculates a representative value in accordance with a predetermined representative value calculation method based on the temperatures of the plurality of durations. Furthermore, the control unit sets the target voltage to be higher as the representative value increases.

The vehicular backup device of the fourth aspect is able to set the target voltage to be higher as the temperature of the auxiliary power source or around the auxiliary power source while the vehicle is stopped increases. Therefore, this vehicular backup device is able to set the target voltage for the next start to be higher as the degree of degradation of the auxiliary power source due to temperature while the vehicle is stopped increases.

### Fifth Aspect

In a fifth aspect, the vehicle backup device described in any of the first to the fourth aspects, the control unit sets the target voltage based on temperatures exceeding a threshold temperature, among temperatures detected by the temperature detection unit when the start switch is OFF.

The vehicular backup device of the fifth aspect is, in the case where the temperature of the auxiliary power source or around the auxiliary power source exceeds the threshold temperature while the vehicle is stopped, able to set the target voltage to reflect that high temperature.

### Sixth Aspect

In a sixth aspect, the vehicular backup device according to any of the first to the fourth aspects, in a case where the temperature detection unit detects temperatures of a plurality of durations when the start switch is OFF, the control unit calculates evaluation values obtained by multiplying the temperatures of the plurality of durations by respective weights in accordance with a predetermined weighting method for multiplying the temperature by a higher weight as the temperature increases. Furthermore, the control unit sets the target voltage based on the plurality of evaluation values.

The vehicular backup device of the sixth aspect is able to set the target voltage so as to increase the degree of reflection as the temperature of the auxiliary power source or around the auxiliary power source that is detected while the vehicle is stopped increases.

### Seventh Aspect

In a seventh aspect, the vehicular backup device according to any of the first to the sixth aspects, after the start switch turns OFF, the control unit, in a first duration, detects the temperature every first time period, and, in a second duration after the first duration, detects the temperature every second time period which is longer than the first time period.

The vehicular backup device of the seventh aspect is able to acquire the temperature every first time period at a relatively early stage after the start switch turns OFF, and, after entering the second duration, is able to reduce the processing load of temperature detection.

### Eighth Aspect

In an eighth aspect, the vehicular backup device according to the first aspect, after the start switch turns OFF, the control unit, in a first duration, detects the temperature at predetermined times determined in advance, and, in a second duration after the first duration, detects the temperature only at a specific time, among the predetermined times, determined based on the temperatures detected in the first duration.

The vehicular backup device of the eighth aspect is able to acquire the temperatures of predetermined times at a relatively early stage after the start switch turns OFF, and, after entering the second duration, is able to reduce the processing load of temperature detection, by performing temperature detection focusing on a specific time among the predetermined times.

### Ninth Aspect

In a ninth aspect, the vehicular backup device according to [8] above, the control unit determines only the time at which a highest temperature is detected in the first duration to be the specific time.

The vehicular backup device of the ninth aspect is able to efficiently detect the temperature of a time that is highly likely to affect degradation of the auxiliary power source in the second duration.

### Tenth Aspect

In a tenth aspect, the vehicular backup device according to the eighth aspect, the control unit determines only the time at which a highest temperature is detected and the time at which a lowest temperature is detected in the first duration to be the specific time.

The vehicular backup device of the tenth aspect is also able to detect the lowest temperature in the second duration, while efficiently detecting the temperature of a time that is highly likely to affect degradation of the auxiliary power source.

### Eleventh Aspect

In an eleventh aspect, the vehicular backup device according to the eighth aspect, the control unit determines the time at which a temperature higher than a second threshold temperature is detected in the first duration to be the specific time.

The vehicular backup device of the eleventh aspect is able to broadly detect the temperatures of times that are highly likely to affect degradation of the auxiliary power source in the second duration.

### Twelfth Aspect

In a twelfth aspect, the vehicular backup device according to the eleventh aspect, the control unit, in a case where a temperature higher than the second threshold temperature is detected in the first duration, determines only the time at which the temperature higher than the second threshold temperature is detected to be the specific time, and detects the temperature at the specific time every first number of days in the second duration, and, in a case where a temperature higher than the second threshold temperature is not detected in the first duration, determines only the time at which a highest temperature is detected to be the specific time, and detects the temperature at the specific time every second number of days in the second duration, the second number of days being longer than the first number of days.

The vehicular backup device of the eleventh aspect is able to reflect the temperature information of the second duration in the target voltage, by detecting, in the second duration, the temperature of the time at which the highest temperature in the first duration was detected, even if a temperature exceeding the second threshold temperature is not detected in the first duration.

### Thirteenth Aspect

In a thirteenth aspect, the vehicular backup device according to any of the first to the twelfth aspects, in a case where it is determined that the auxiliary power source has been removed, the control unit sets the target voltage based only on the temperature detected before removal is determined.

The vehicular backup device of is the thirteenth aspect, in the case where the auxiliary power source has possibly been removed, able to set the target voltage with the effect of temperature after removal eliminated.

### Fourteenth Aspect

In a fourteenth aspect, the vehicular backup device according to any of the first to the thirteenth aspects, in a case where it is determined that the auxiliary power source has been removed, the control unit outputs a notification that the auxiliary power source has been removed.

The vehicular backup device of is the fourteenth aspect, in the case where the auxiliary power source has possibly been removed, able to notify the user or the like that the auxiliary power source has been removed.

### Fifteenth Aspect

In a fifteenth aspect, the vehicular backup device of the fourth aspect, or the vehicular backup device according to any of the fifth to seventh, thirteenth and fourteenth aspects, dependent on the fourth aspect, the representative value is a mean value of the temperatures of the plurality of durations calculated by a predetermined method or a mean value of temperatures exceeding the threshold temperature among the temperatures of the plurality of durations calculated by a predetermined method.

The vehicular backup device of the fifteenth aspect is able to set the target voltage to reflect the average temperature environment of the auxiliary power source or around the auxiliary power source that exists while the vehicle is stopped.

### First Embodiment

### 1. Basic Configuration of Vehicular Backup Device

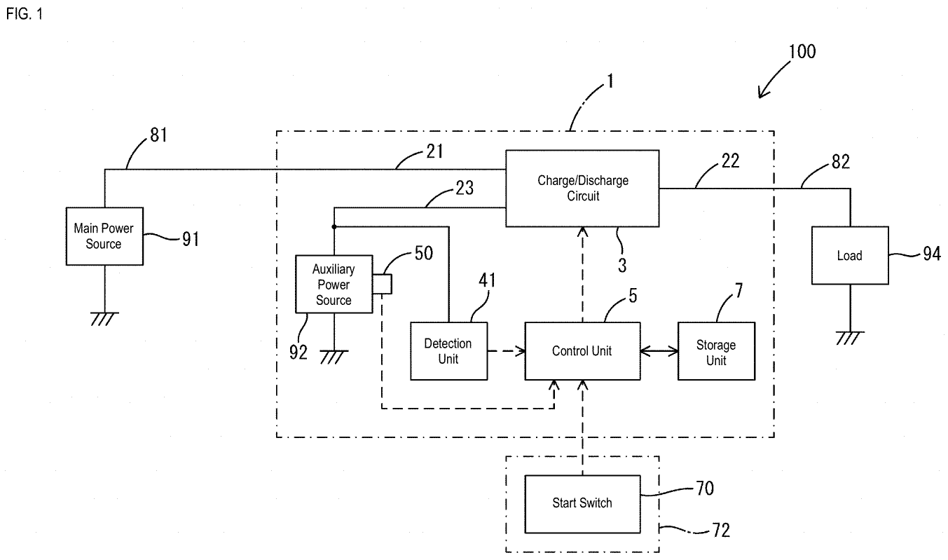

A vehicular power system 100 shown in FIG. 1 is a power system including a vehicular backup device 1 according to a first embodiment.

The power system 100 shown in FIG. 1 is a system for supplying power to a load 94. The power system 100 operates according to signals from an external device 72. The power system 100 includes a main power source 91, the backup device 1, and an auxiliary power source 92. The power system 100 is constituted as a system for supplying power to the load 94 with the main power source 91 or the auxiliary power source 92 as the power supply source.

In the power system 100, a voltage that is based on the output voltage of the main power source 91 is applied to a wiring part 81 when power supply from the main power source 91 is in a normal state. Power that is supplied from the main power source 91 can be transmitted via the wiring part 81, and power that is based on this transmitted power can be supplied to the load 94 (power supply target). The power supply from the main power source 91 is in a normal state when the output voltage of the main power source 91 exceeds a predetermined value, and is, for example, when the voltage (potential) of a first conductive path 21 exceeds a predetermined threshold value in a state where the auxiliary power source 92 is not being discharged.

Note that, in the following description, “voltage” means the potential difference from ground potential (e.g., 0 V) unless specified otherwise. For example, the voltage of a third conductive path 23 means the potential difference between the potential of the third conductive path 23 and ground potential.

The main power source 91 is a vehicular power source that can supply power to the load 94 which is the power supply target. The main power source 91 is constituted as a known in-vehicle battery such as a lead battery, for example. In the main power source 91, a terminal on the high potential side is electrically connected to the wiring part 81, and a predetermined output voltage (e.g., so-called +B voltage) is applied to the wiring part 81. A terminal on the low potential side of the main power source 91 is electrically connected to ground, for example, and has ground potential, for example.

The wiring part 81 is part of the path for supplying power from the main power source 91 to the load 94 (power supply target). The wiring part 81 is electrically connected to the first conductive path 21 of the backup device 1. The output voltage of the main power source 91 is applied to the first conductive path 21 via the wiring part 81. The wiring part 81 and the first conductive path 21 have the same voltage, for example. An element such as a switch may be interposed on the wiring part 81.

A wiring part 82 is part of the path for supplying power from the main power source 91 to the load 94 (power supply target). The wiring part 82 is electrically connected to the load 94, and has the same potential as part of the load 94, for example. The wiring part 82 is electrically connected to a second conductive path 22 of the backup device 1, and, herein, has the same potential as the second conductive path 22. That is, the voltage that is applied to the second conductive path 22 is applied to the load 94 via the wiring part 82. An element such as a switch may be interposed on the wiring part 82.

The auxiliary power source 92 is a power source that functions as the power supply source at least when power supply from the main power source 91 is interrupted. The auxiliary power source 92 is constituted by a power storage device such as an electric double layer capacitor (EDLC), for example. A terminal on the high potential side of the auxiliary power source 92 is electrically connected to the third conductive path 23. The output voltage of the auxiliary power source 92 is applied to part of a charge/discharge circuit 3 via the third conductive path 23. A terminal on the low potential side of the auxiliary power source 92 is electrically connected to ground, for example, and has ground potential, for example. The auxiliary power source 92 is charged and discharged by the charge/discharge circuit 3. The output voltage of the auxiliary power source 92 when fully charged may be higher or lower than the output voltage of the main power source 91 when fully charged.

The load 94 corresponds to an example of a power supply target. The load 94 is constituted as a known vehicular electrical component. The load 94 is, for example, desirably an electrical component or the like to which power supply is desirable even if the main power source 91 fails, such as an ECU or an actuator, and may be an electrical component other than an ECU, actuator or the like. The load 94 operates based on power that is supplied from the main power source 91 when in the “normal state” described above, and operates based on power that is supplied from the auxiliary power source 92 when in an “abnormal state” described later.

A start switch 70 is constituted as a known ignition switch. The start switch 70 turns ON when a predetermined start operation for starting an engine (e.g., ON operation of an ignition switch) is performed on an operation unit (not shown) provided in a vehicle in which the power system 100 is installed. The start switch 70 turns OFF when a predetermined stop operation (e.g., OFF operation of the ignition switch) for stopping the engine is performed on the operation unit. When the start switch 70 is ON, an ignition ON signal (hereinafter also referred to as an IG ON signal) indicating that the start switch 70 is ON is input to the control unit 5 of the backup device 1 from the external device 72 provided outside the backup device 1. When the start switch 70 is OFF, an ignition OFF signal (hereinafter also referred to as an IG OFF signal) indicating that the start switch 70 is OFF is input to the control unit 5 from the external device 72.

The backup device 1 is provided with a function of quickly performing discharging of the auxiliary power source 92 when power supply from the main power source 91 is interrupted. This backup device 1 is also the device that controls charging and discharging of the auxiliary power source 92. The backup device 1 mainly includes the first conductive path 21, the second conductive path 22, the third conductive path 23, the charge/discharge circuit 3, a detection unit 41 (voltage detection unit), a temperature detection unit 50, and the control unit 5.

The first conductive path 21 is electrically connected to the terminal on the high potential side of the main power source 91. A predetermined DC voltage that depends on the output voltage of the main power source 91 is applied to the first conductive path 21.

The second conductive path 22 is electrically connected to the load 94. The voltage that is supplied via the charge/discharge circuit 3 is applied to the second conductive path 22.

The third conductive path 23 is electrically connected to the terminal on the high potential side of the auxiliary power source 92. A predetermined DC voltage that depends on the output voltage of the auxiliary power source 92 is applied to the third conductive path 23. The third conductive path 23 is electrically connected to the charge/discharge circuit 3.

The charge/discharge circuit 3 performs operations for charging and discharging the auxiliary power source 92. The charge/discharge circuit 3 has a function as a discharge circuit that discharges the main power source 91 and supplies a current to the wiring part 82 based on power that is supplied from the main power source 91 via the first conductive path 21. The charge/discharge circuit 3 also has a function as a charge circuit that charges the auxiliary power source 92 based on power supplied from the main power source 91 via the first conductive path 21. The charge/discharge circuit 3 also has a function as a discharge circuit that discharges the auxiliary power source 92 and supplies a current to the wiring part 82 based on power that is supplied from the auxiliary power source 92 via the third conductive path 23.

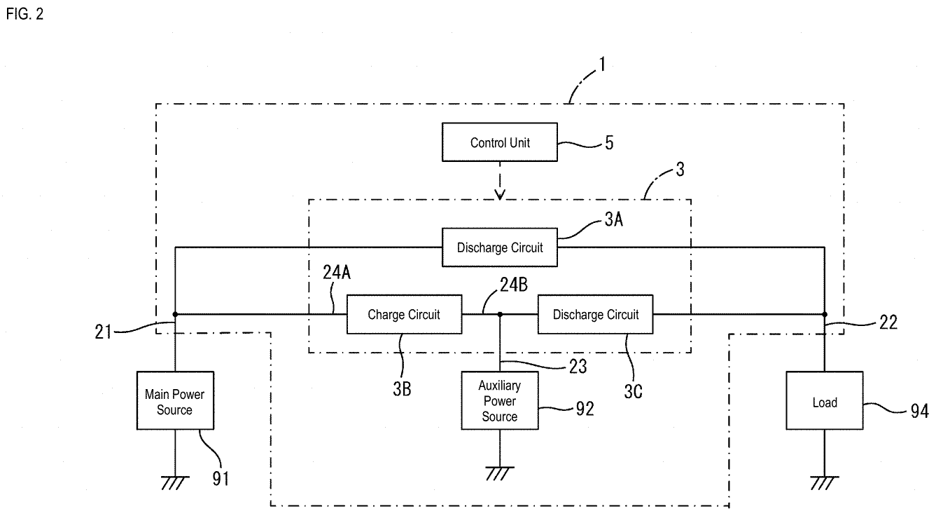

The charge/discharge circuit 3 can be constituted as shown in FIG. 2. The charge/discharge circuit 3 shown in FIG. 2 includes a discharge circuit 3A, a charge circuit 3B, and a discharge circuit 3C.

The discharge circuit 3A is a circuit through which the main power source 91 is discharged. The discharge circuit 3A may be constituted by a DC-DC converter that steps up or steps down the voltage that is applied to the first conductive path 21 and applies the output voltage to the second conductive path 22. The discharge circuit 3A may also be constituted by a relay (semiconductor relay, mechanical relay, etc.) that switches the first conductive path 21 and the second conductive path 22 between a conductive state and a non-conductive state. The discharge circuit 3A may also be constituted by a diode whose anode is connected to the first conductive path 21 and whose cathode is connected to the second conductive path 22.

The charge circuit 3B is a charge circuit that supplies a charge current to the auxiliary power source 92 based on power that is supplied from the main power source 91 via the first conductive path 21. The charge circuit 3B may be constituted by a DC-DC converter that steps up or steps down the voltage that is applied to the first conductive path 21 and applies the output voltage to the third conductive path 23. The charge circuit 3B may also be constituted by a relay (semiconductor relay, mechanical relay, etc.) that switches the first conductive path 21 and the third conductive path 23 between a conductive state and a non-conductive state. Note that, in a representative example described below, the charge circuit 3B is constituted by a DC-DC converter that steps up or steps down the voltage that is applied to the first conductive path 21 and applies the output voltage to the third conductive path 23.

The discharge circuit 3C is a circuit through which the auxiliary power source 92 is discharged. The discharge circuit 3C may be constituted by a DC-DC converter that steps up or steps down the voltage that is applied to the third conductive path 23 and applies the output voltage to the second conductive path 22. The discharge circuit 3C may also be constituted by a relay (semiconductor relay, mechanical relay, etc.) that switches the third conductive path 23 and the second conductive path 22 between a conductive state and a non-conductive state. The discharge circuit 3C may also be constituted by a diode whose anode is connected to the third conductive path 23 and whose cathode is connected to the second conductive path 22.

The detection unit 41 shown in FIG. 1 is constituted as a known voltage detection circuit. The detection unit 41 inputs a value indicating the voltage (potential) of the third conductive path 23 (e.g., voltage value of the third conductive path 23, value obtained by dividing the voltage value of the third conductive path 23 with a voltage divider circuit, etc.) to the control unit 5 as a detection value. The control unit 5 ascertains the voltage value (potential) of the third conductive path 23 based on the value input from the detection unit 41 (detection value of the detection unit 41). The voltage value of the third conductive path 23 is a value indicating the charge voltage (output voltage) of the auxiliary power source 92. The charge voltage (output voltage) of the auxiliary power source 92 corresponds to an inter-terminal voltage between the terminal on the high potential side terminal and terminal on the low potential side in the auxiliary power source 92.

The temperature detection unit 50 is constituted by a known temperature sensor, and is, for example, disposed in contact with the surface of the auxiliary power source 92 directly or via another member, or in proximity to the auxiliary power source 92 so as to detect the temperature around the auxiliary power source 92 (specifically, opposing the auxiliary power source 92 at a position where the heat of the auxiliary power source 92 is transferred to the temperature sensor, for example). The temperature detection unit 50 generates an analog voltage value indicating the temperature of the disposition position (temperature in the vicinity of the auxiliary power source 92) and inputs the generated analog voltage value to the control unit 5.

The control unit 5 has a control circuit constituted as a microcomputer, for example. The control unit 5 controls the charging operation and the discharging operation of the charge/discharge circuit 3, for example. Specifically, the control unit 5 controls the discharging operation of the discharge circuit 3A, the charging operation of the charge circuit 3B, and the discharging operation of the discharge circuit 3C. Note that the discharge circuit 3A or the discharge circuit 3C may also have configuration (e.g., configuration composed of a diode) that is not controlled by the control unit 5.

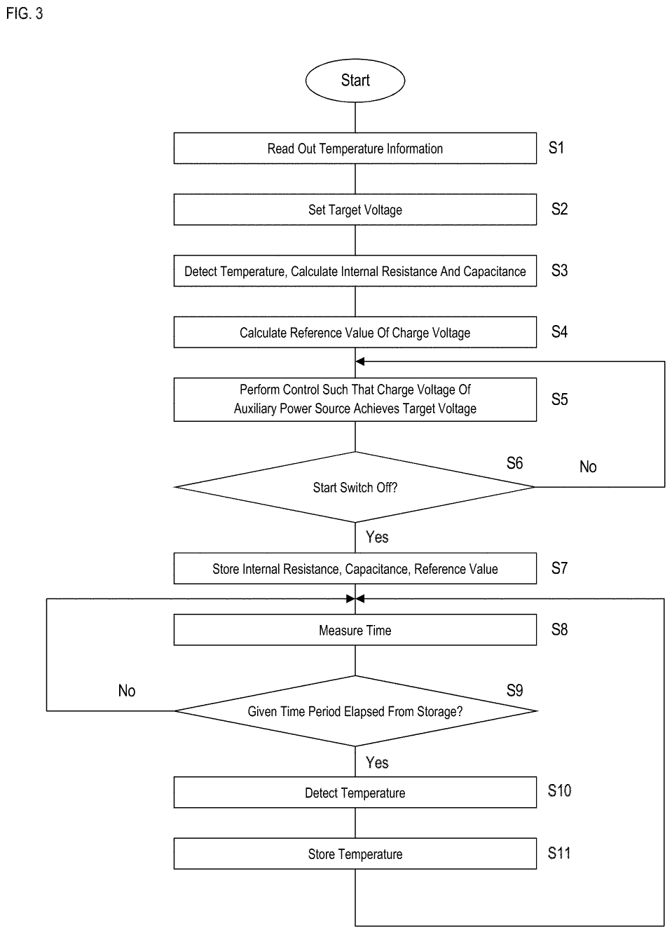

The storage unit 7 has one or more storage devices. The storage unit 7 has semiconductor memories such as a ROM, a RAM and a non-volatile memory, for example, and can store various information. For example, the storage unit 7 has a function of storing a program for executing the control of FIG. 3, temperature information, and the like.

### 2. Control of Backup Device

The following description relates to control that is performed by the backup device 1.

The control unit 5 starts the control of FIG. 3 when a condition for starting the vehicle is established. Also, if the condition for starting the vehicle is established after a condition for stopping the vehicle is established, the control of FIG. 3 is initially ended and then immediately restarted. The condition for starting the vehicle is, specifically, established when a signal indicating that the start switch 70 is ON starts being input to the control unit 5. In the following description, the condition for starting the vehicle is established when the signal from the external device 72 that is input to the control unit 5 switches from the IG OFF signal to the IG ON signal. The condition for stopping the vehicle is, specifically, established when a signal indicating that the start switch 70 is OFF starts being input to the control unit 5. In the following description, the condition for stopping the vehicle is established when the signal from the external device 72 that is input to the control unit 5 switches from the IG ON signal to the IG OFF signal.

The control unit 5 starts the control of FIG. 3 when the condition for starting the vehicle is established, and, first, reads out temperature information in step S1. The temperature information read out in step S1 is information that is stored in the processing of step S11 described later, and is based on the temperature detected by the temperature detection unit 50 during the period in which the vehicle is stopped.

After step S1, the control unit 5, in step S2, sets a target voltage Vt of the auxiliary power source 92. The target voltage Vt is the charge voltage of the auxiliary power source 92 to be targeted during vehicle operation. In step S2, the control unit 5 sets the target voltage Vt of the auxiliary power source 92, based on a reference value Vb of the charge voltage obtained in step S4 of the previous control of FIG. 3 and the temperature information read out in step S1. This target voltage Vt is used in step S5 described later. Note that steps S1 and S2 will be described in further detail in later.

After step S2, the control unit 5, in step S3, checks the temperature in the vicinity of the auxiliary power source 92 and calculates the internal resistance and capacitance of the auxiliary power source 92. In step S3, the control unit 5 acquires a detection value that is provided from the temperature detection unit 50. Furthermore, in step S3, the control unit 5 performs a charging operation for charging the auxiliary power source 92 and a stop operation for stopping charging during the charging operation, and during the period in which such operations are being performed, the current flowing through a conductive path 24A and the voltage of the conductive path 24A are detected, and the current flowing through a conductive path 24B and the voltage of the conductive path 24B are detected. Note that a current detection unit and a voltage detection unit that are not shown are provided on the conductive path 24A, and respective detection values indicating the value of the current flowing through the conductive path 24A and the value of the voltage that is applied to the conductive path 24A are input to the control unit 5. Similarly, a current detection unit and a voltage detection unit that are not shown are provided on the conductive path 24B, and respective detection values indicating the value of the current flowing through the conductive path 24B and the value of the voltage that is applied to the conductive path 24B are input to the control unit 5. The control unit 5 then calculates the internal resistance and capacitance of the auxiliary power source 92, based on the current value and voltage value of the conductive path 24A and the current value and voltage value of the conductive path 24B that are obtained in the process of performing the charging operation and stop operation described above. Any known methods may be used for the methods of calculating the internal resistance and capacitance of the auxiliary power source 92, and any known operations may be employed for the operations (charging operation, stop operation, discharging operation, etc.) necessary for calculating the internal resistance and capacitance. Specifically, methods similar to the methods described in JP 2018-068019A, for example, can be suitably used for the methods of calculating the internal resistance and capacitance of the auxiliary power source 92 in step S3. Note that the conductive path 24A is electrically connected at one end to the wiring portion 81 and is electrically connected at the other end to the charge circuit 3B, and, herein, has the same potential as the wiring portion 81. The conductive path 24B is electrically connected at one end to the auxiliary power source 92 and is electrically connected at the other end to the charge circuit 3B, and, herein, has the same potential as the terminal on the high potential side of the auxiliary power source 92.

After step S3, the control unit 5, in step S4, calculates the reference value Vb of the charge voltage. When calculating the reference value Vb of the charge voltage in step S4, the control unit 5 calculates a charge voltage (target voltage) with a similar method to a known method of setting the charge voltage (target voltage) of an auxiliary power source based on the internal resistance and capacitance of the auxiliary power source, and the calculated value can be taken as “the reference value Vb of the charge voltage”. Specifically, for example, the control unit 5 calculates a second target voltage value with a similar method to the method of calculating a second target voltage value in the invention described in JP 2018-068019A based on the temperature of the auxiliary power source 92 and the internal resistance and capacitance of the auxiliary power source 92 that are obtained in step S3, and this second target voltage value can be taken as “the reference value Vb of the charge voltage”.

After step S4, the control unit 5, in step S5, controls the charge/discharge circuit 3 such that the charge voltage of the auxiliary power source 92 achieves the target voltage Vt set in step S2. After step S5, the control unit 5 determines whether the start switch 70 is OFF, repeats the processing of steps S5 and S6 until the start switch 70 turns OFF, and maintains the charge voltage of the auxiliary power source 92 at the target voltage Vt. In this way, the control unit 5 operates to cause the charge/discharge circuit 3 to perform an operation such that the charge voltage of the auxiliary power source 92 achieves the target voltage Vt on condition that the start switch 70 of the vehicle is ON.

If it is determined in step S6 that the start switch 70 is OFF, the control unit 5, in step S7, stores the internal resistance and capacitance calculated in step S3 and the reference value Vb of the charge voltage calculated in step S4 in the storage unit 7.

After step S7, the control unit 5, in step S8, performs time measurement. The time measurement in step S8 is measurement of elapsed time from the storage of step S7 or elapsed time from the storage of step S11. After step S8, the control unit 5, in step S9, determines whether a given time period has elapsed from storage. If the processing of step S11 has not yet been performed at the time of the determination of step S9, the control unit 5 determines whether the given time period has elapsed from the storage of step S7. If the processing of step S11 has already been performed at the time of the determination of step S9, the control unit 5 determines whether the given time period has elapsed from the storage of step S11. In step S9, the control unit 5 repeats the determination of step S9 if it is determined that the given time period has not elapsed from the storage of step S7 or step S11, and performs temperature detection in step S10 if it is determined that the given time period has elapsed from storage. In step S10, the control unit 5 acquires a detection value from the temperature detection unit 50, and, in step S11 after step S10, stores the temperature detected in the immediately previous step S10.

As a result of such operations being performed, the control unit 5 is able to acquire the temperature that is detected by the temperature detection unit 50 after a given time period elapses while the start switch 70 is maintained in the OFF state, after the start switch 70 turns OFF.

The control unit 5 continuously performs the processing from step S9 while the start switch 70 is OFF. Accordingly, the control unit 5 is able to acquire the temperature detected by the temperature detection unit 50 every predetermined time period in the case where the start switch 70 is maintained in the OFF state. If the start switch 70 turns ON when the processing from step S9 is being continuously performed in this way, the control unit 5 then stops the processing from step S9 and newly starts the control of FIG. 3.

### 3. Detail Description of Method of Setting Target Voltage

The following is a detailed description of the method of setting the target voltage.

When setting the target voltage of the auxiliary power source 92 in step S2 of the control of FIG. 3, the control unit 5 sets the target voltage based on the temperature stored in step S11 of the control of FIG. 3 (previous control of FIG. 3) performed immediately previously to the current control of FIG. 3 in which this control of step S2 is performed. That is, the control unit 5 sets the target voltage based on the temperature stored in step S11 during the OFF period of the start switch immediately previous to the current OFF period of the start switch. In the following description, the control of FIG. 3 in which setting of the target voltage in step S2 is currently being performed will be referred to as “the current control of FIG. 3”, and the control performed most recently out of the controls of FIG. 3 performed before the start of “the current control of FIG. 3” will be referred to as “the previous control of FIG. 3”.

When setting the target voltage of the auxiliary power source 92 in step S2 of the current control of FIG. 3, the control unit 5, in the case where one or more temperatures were stored in step S11 of the previous control of FIG. 3, reads out the stored one or more temperatures in step S1 of the current control of FIG. 3. In step S2 of the current control of FIG. 3, the control unit 5 then sets the target voltage based on the one or more temperatures read out in the immediately previous step S1. Specifically, the control unit 5 derives a representative value from among the one or more temperatures (temperatures detected by the temperature detection unit 50 when the start switch is OFF) stored in step S11 of the previous control of FIG. 3, and sets the target voltage such that the target voltage is higher as the representative value increases.

The control unit 5 is able to calculate the representative value as follows, for example. In the case where one or more temperatures (one or more temperatures stored in step S11 of the previous control of FIG. 3) are read out in step S1 of the current control of FIG. 3, the control unit 5 extracts temperatures exceeding a threshold temperature from the read temperatures.

Next, an example will be described in which, for example, the temperatures stored in step S11 of the previous control of FIG. 3 are nine temperatures −10° C., 30° C., 60° C., 50° C., 80° C., 90° C., 100° C., 50° C. and 20° C., and the threshold temperature is 55° C. In this example, in step S1 of the current control of FIG. 3, the control unit 5 reads out the nine stored temperatures (−10° C., 30° C., 60° C., 50° C., 80° C., 90° C., 100° C., 50° C., 20° C.). In the next step S2, the control unit 5 then extracts temperatures (60° C., 80° C., 90° C., 100° C.) that exceed the threshold temperature (55° C.) from the read temperatures. Furthermore, in step S2, the control unit 5 calculates the representative value, by performing statistical processing on the extracted temperatures (60° C., 80° C., 90° C., 100° C. which are temperatures exceeding the threshold temperature). The statistical processing may be processing for calculating a mean value, processing for calculating a median value, processing for calculating a maximum value, or processing for calculating a minimum value from the extracted temperatures (temperatures exceeding the threshold temperature). The processing for calculating the mean value may be processing for calculating an arithmetic mean, processing for calculating a geometric mean, or processing for calculating a harmonic mean. Note that, hereinafter, an example using processing for calculating an arithmetic mean as statistical processing will be described as a representative example.

In the representative example, the control unit 5 calculates the arithmetic mean of the temperatures extracted as temperatures exceeding the threshold temperature from the temperatures read out in step S1 of the current control of FIG. 3. For example, in the case where the temperatures read out in step S1 are the above nine temperatures, and four temperatures (60° C., 80° C., 90° C., 100° C.) are extracted as temperatures exceeding the threshold temperature (55° C.), the control unit 5 derives the arithmetic mean of those four temperatures. The control unit 5 then takes 82.5° C., which is the value of the arithmetic mean ((60+80+90+100)/4) as the representative value, and calculates the target voltage based on this representative value.

More specifically, a table or equation for determining a coefficient a based on the representative value is determined in advance, and in the case where the representative value is determined in step S2 of the current control of FIG. 3, the control unit 5 determines the coefficient a with the table or equation. The table or equation defines the correspondence relationship between the representative value and the target voltage such that the target voltage is higher as the representative value increases. In the case where an equation is used, the equation may be, for example, a proportional equation that determines the target voltage proportionally to the representative value, or may otherwise be a linear or quadratic equation. In the case where a table is used, the table may be, for example, a table that determines a coefficient for each temperature range, or may be a table that determines each temperature specifically and determines a coefficient for each temperature. Note that, in the representative example described below, a table is used in which temperature ranges of the representative value are associated with coefficients α, such that the coefficient α is 1.00 from 50° C. to less than 60° C., the coefficient α is 1.25 from 60° C. to less than 70° C., the coefficient α is 1.50 from 70° C. to less than 80° C., the coefficient α is 1.75 from 80° C. to less than 90° C., and so on.

In the case where the representative value 82.5° C. is calculated as described above, and the table described above is used, the control unit 5 determines 1.75, which is the coefficient corresponding to the temperature range to which 82.5° C. belongs, as α. In step S2 of the current control of FIG. 3, the control unit 5 then determines the charge voltage Vt (target voltage Vt) of the target auxiliary power source 92, based on the coefficient α thus determined and the reference value Vb of the charge voltage calculated in step S4 of the previous control of FIG. 3. Specifically, the control unit 5 calculates the charge voltage Vt to be targeted (target voltage Vt) with the equation Vt=Vb×α. The target voltage Vt thus determined is used in step S5 as described above, and the control unit 5 operates so as to execute step S5 during vehicle operation such that the charge voltage of the auxiliary power source 92 achieves the target voltage Vt.

Note that in the case where temperature information is not stored in the previous control of FIG. 3, the control unit 5, in step S2 of the current control of FIG. 3, may take, as the target voltage to be determined, “the reference value of the charge voltage” calculated in step S4 of the previous control of FIG. 3 or “the reference value of the charge voltage” calculated in step S4 of the current control of FIG. 3.

### 4. Operations at Time of Power Loss

The backup device 1 constituted as described above causes the auxiliary power source 92 to function as a power supply source, at least in the case where power supply from the main power source 91 becomes abnormal during vehicle operation (when the start switch 70 is ON). Specifically, the control unit 5 monitors the voltage of the first conductive path 21 during vehicle operation, and, if the voltage of the first conductive path 21 drops to less than a predetermined voltage Vth determined in advance, controls the discharge circuit 3C to perform the discharging operation. Accordingly, if power supply from the main power source 91 becomes abnormal when the charge voltage of the auxiliary power source 92 is being maintained at the target voltage Vt, the backup device 1 is able to start a backup operation in a state where the auxiliary power source 92 outputs the target voltage Vt. That is, the output voltage of the auxiliary power source 92 at the start of the backup operation will be a value that reflects the temperature state while the vehicle is stopped.

### 5. Example of Effects

The following description relates to the effects of the first embodiment.

The backup device 1 is able to set the target voltage Vt at the time of charging the auxiliary power source 92 after starting vehicle operation, based on the temperature that is detected by the temperature detection unit 50 when the start switch 70 is OFF. Therefore, the backup device 1 is able to set the charge voltage of the auxiliary power source 92 to reflect the temperature state during the period in which the vehicle is stopped.

Specifically, the backup device 1 is able to set the target voltage Vt to reflect the temperature of the auxiliary power source 92 or around the auxiliary power source 92 after a certain amount of time elapses after the start switch 70 turns OFF.

More specifically, the backup device 1 is able to set the target voltage Vt to reflect the temperature of the auxiliary power source 92 or around the auxiliary power source 92 periodically detected while the vehicle is stopped. Therefore, the target voltage Vt can be set to more strongly reflect the temperature environment that exists while the vehicle is stopped.

The backup device 1 is able to set the target voltage Vt such that the target voltage Vt is higher as the temperature of the auxiliary power source 92 or around the auxiliary power source 92 while the vehicle is stopped increases. Therefore, this backup device 1 is able to set the target voltage Vt for the next start to be higher as the degree of degradation of the auxiliary power source due to the temperature while the vehicle is stopped increases.

The backup device 1 is able to set the target voltage Vt to more strongly reflect the high temperature state, in the case where the temperature of the auxiliary power source 92 or around the auxiliary power source 92 exceeds a threshold temperature while the vehicle is stopped.

The backup device 1 employs a mean value as the representative value, and is able to set the target voltage Vt to reflect the average temperature environment of the auxiliary power source 92 or around the auxiliary power source 92 that exists while the vehicle is stopped.

### Second Embodiment

The backup device 1 of a second embodiment differs from the first embodiment with regard to only the above section “3. Detailed Description of Target Voltage Setting Method”, and is the same as the first embodiment with regard to the sections “1. Basic Configuration of Vehicular Backup Device”, “2. Control of Backup Device”, and “4. Operations at time of Power Loss”. Also, the contents of FIGS. 1 to 3 are the same for the backup device 1 of the first embodiment and the backup device 1 of the second embodiment. Therefore, in the following description, FIGS. 1 to 3 will be referenced as diagrams related to the backup device 1 of the second embodiment.

In the backup device 1 of the second embodiment, when setting the target voltage of the auxiliary power source 92 in step S2 in the control of FIG. 3, the control unit 5 similarly sets the target voltage based on the temperature stored in step S11 in the control of FIG. 3 (previous control of FIG. 3) performed immediately previously to the current control of FIG. 3 in which this control of step S2 is performed. That is, the control unit 5 sets the target voltage Vt based on the temperature stored in step S11 during the OFF period of the start switch immediately previous to the current OFF period of the start switch.

In the current control of FIG. 3, in the case where one or more temperatures are stored in step S11 of the previous control of FIG. 3 when setting the target voltage of the auxiliary power source 92 in step S2, the control unit 5 reads out the one or more stored temperatures in step S1 of the current control of FIG. 3. In step S2 of the current control of FIG. 3, the control unit 5 then sets the target voltage based on the one or more temperatures read out in the immediately previous step S1. Specifically, the control unit 5 derives a representative value from among the one or more temperatures stored in step S11 of the previous control of FIG. 3 (one or more temperatures detected by the temperature detection unit 50 when the start switch is OFF), and sets the target voltage to be higher as the representative value increases.

The control unit 5 is able to calculate the representative value as follows, for example. In the case where one or more temperatures (one or more temperatures stored in step S11 of the previous control of FIG. 3) are read out in step S1 of the current control of FIG. 3, the control unit 5 calculates the weighted mean of the read temperatures as statistical processing and calculates the representative value.

Next, an example will be described in which the temperatures stored in step S11 of the previous control of FIG. 3 are nine temperatures −10° C., 30° C., 60° C., 50° C., 80° C., 90° C., 100° C., 50° C., and 20° C., and the threshold temperature is 55° C. In this example, in step S1 of the current control of FIG. 3, the control unit 5 reads out the nine stored temperatures (−10° C., 30° C., 60° C., 50° C., 80° C., 90° C., 100° C., 50° C., 20° C.).

In the present embodiment, a table or equation for determining the weight by which to multiply each temperature is determined in advance, and the control unit 5 determines the weight corresponding to each temperature with the table or equation. The table or equation defines the correspondence relationship between the temperature and the weight so as to increase the weight as the temperature to be targeted (temperature to be multiplied by the weight) increases. In the case where an equation is used, the equation may be, for example, a proportional equation that determines the weight proportionally to the temperature, or may otherwise be a linear or quadratic equation. In the case where a table is used, the table may be, for example, a table that determines weights for each temperature range, or may be a table that defines each temperature specifically and determines a weight for each temperature. Note that, in the example described below, a table is used in which temperature ranges are associated with weights, such that the weight is 1.00 up to less than 60° C., the weight is 1.25 from 60° C. to less than 70° C., the weight is 1.50 from 70° C. to less than 80° C., the weight is 1.75 from 80° C. to less than 90° C., the weight is 2.00 from 90° C. to less than 100° C., the weight is 2.25 from 100° C. In this example, the control unit 5 derives values obtained by multiplying each temperature read out in step S1 by the weight corresponding to that temperature, and calculates the arithmetic mean of the obtained values. For example, if the temperatures read out in step S1 are −10° C., 30° C., 60° C., 50° C., 80° C., 90° C., 100° C., 50° C. and 20° C., the control unit 5 multiplies each temperature by the weight corresponding to that temperature. The control unit 5 then calculates the arithmetic mean of the values obtained by multiplying the temperatures by the weights. The values obtained by multiplying the temperatures by the weights are nine values: −10×1.00, 30×1.00, 60×1.25, 50×1.00, 80×1.75, 90×2.00, 100×2.25, 50×1.00, and 20×1.00. These values (values obtained by multiplying the temperatures by the weights) correspond to an example of evaluation values. In this case, the control unit 5 calculates 84.4, which is the arithmetic mean of the values, by the equation (((−10)+30+(60×1.25)+50+(80×1.75)+(90×2)+(100×2.25)+50+20)/9). This arithmetic mean is also the weighted mean of the nine temperatures (−10° C., 30° C., 60° C., 50° C., 80° C., 90° C., 100° C., 50° C., 20° C.). The control unit 5 then takes this weighted mean (84.4° C.) as the representative value, and calculates the target voltage based on this representative value. Note that the representative value in this example corresponds to an example of an evaluation value.

When the representative value thus obtained, the method of calculating the target voltage Vt based on the representative value is the same as in the first embodiment. Specifically, the control unit 5 determines the coefficient α with a similar method to the first embodiment based on the representative value. The control unit 5 then calculates the charge voltage Vt to be targeted (target voltage Vt) with the equation Vt=Vb×α. The target voltage Vt thus determined is used in step S5 as described above, and the control unit 5 operates so as to execute step S5 during vehicle operation such that the charge voltage of the auxiliary power source 92 achieves the target voltage Vt.

In the present embodiment as described above, in the case where the temperature detection unit 50 detects temperatures of a plurality of durations when the start switch 70 is OFF, the control unit 5 calculates evaluation values that are obtained by multiplying the temperatures of the plurality of durations by respective weights in accordance with a prescribed weighting method for multiplying the temperature by a higher weight as the temperature increases. The control unit 5 then sets the target voltage Vt based on the plurality of evaluation values (values obtained by multiplying the temperatures by respective weights). In this example, the target voltage Vt can be set so as to increase the degree of reflection as the temperature of the auxiliary power source 92 or around the auxiliary power source 92 that is detected while the vehicle is stopped increases.

### Third Embodiment

The backup device 1 of a third embodiment differs from the first embodiment with regard to only the above section “2. Control of Backup Device”, and is the same as the first embodiment with regard to the sections “1. Basic Configuration of Vehicular Backup Device”, “3. Detailed Description of Target Voltage Setting Method”, and “4. Operations at time of Power Loss”. Also, the contents of FIGS. 1 and 2 are the same for the backup device 1 of the first embodiment and the backup device 1 of the third embodiment. Therefore, in the following description, FIGS. 1 and 2 will be referenced as diagrams related to the backup device 1 of the third embodiment.

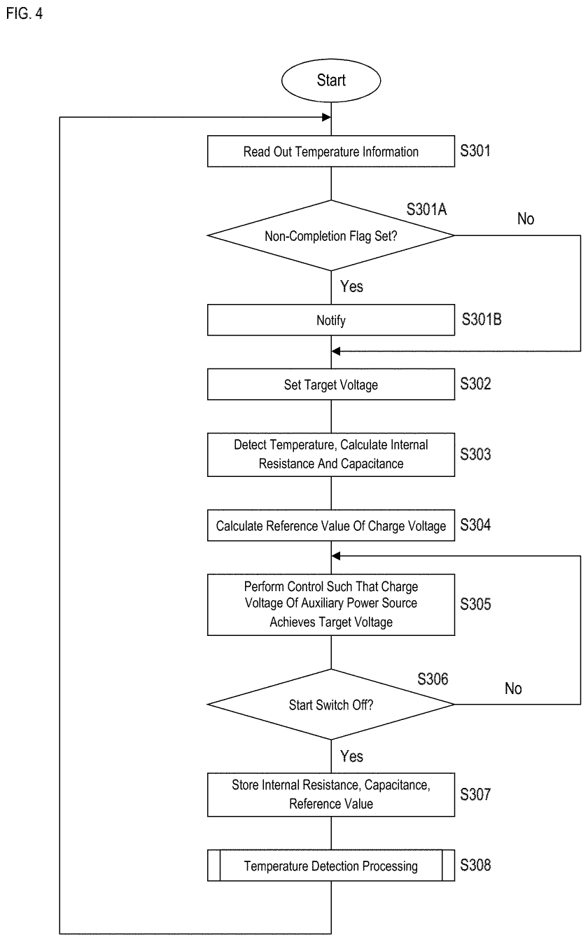

The control unit 5 starts the control of FIG. 4 if the control of FIG. 4 is not being executed in the case where the condition for starting the vehicle is established. Establishment of the condition for starting the vehicle is the same as establishment of the condition for starting the vehicle in the first embodiment. The control unit 5 ends the control of FIG. 4, if it is determined that the auxiliary power source 92 has been removed. The control unit 5 determines that the auxiliary power source 92 has been removed, when the output voltage of the auxiliary power source 92 drops to less than or equal to a predetermined OFF-time threshold, for example.

The control unit 5 starts the control of FIG. 4 when the condition for starting the vehicle is established, and, first, reads out temperature information in step S301. The temperature information read out in step S301 is information that is stored in the processing of step S329 described later, and is based on the temperature detected by the temperature detection unit 50 during the period in which the vehicle is stopped.

After step S301, the control unit 5, in step S301A, determines whether a non-completion flag is set. Here, the non-completion flag is a flag indicating that temperature detection processing for detecting the temperature during the period in which the vehicle is stopped has not been completed. The non-completion flag is set when the condition for stopping the vehicle is established, and is cleared when the condition for starting the vehicle is established. It is thus, normally, determined in step S301A that the non-completion flag is not set. However, if it is determined that the auxiliary power source 92 has been removed when the vehicle is in the stopped state, the control of FIG. 4 ends with the non-completion flag set, and the control of FIG. 4 is started when the condition for starting the vehicle is established. The control unit 5 thus determines that the non-completion flag is set in step S301A.

If it is determined in step S301A that the non-completion flag is set, the control unit 5, in step S301B, outputs a notification that the auxiliary power source 92 has been removed. The method of notification may involve notification means provided in the backup device 1 being controlled to perform the notification, or may involve notification means provided outside the backup device 1 being caused, via an external ECU, to perform the notification.

If it is determined in step S301A that the non-completion flag is not set, or after step S301B, the control unit 5, in step S302, sets the target voltage Vt of the auxiliary power source 92. Since the method of setting the target voltage Vt of the auxiliary power source 92 is the same as described in the section “3. Detailed Description of Target Voltage Setting Method” of the first embodiment, a detailed description thereof will be omitted.

After step S302, the control unit 5, in step S303, checks the temperature in the vicinity of the auxiliary power source 92 and calculates the internal resistance and capacitance of the auxiliary power source 92. Since the method of calculating the internal resistance and capacitance of the auxiliary power source 92 is the same as in step S3 of the first embodiment, a detailed description thereof will be omitted.

After step S303, the control unit 5, in step S304, calculates the reference value Vb of the charge voltage. Since the method of calculating the reference value Vb of the charge voltage is the same as in step S4 of the first embodiment, a detailed description thereof will be omitted.

After step S304, the control unit 5, in step S305, controls the charge/discharge circuit 3 such that the charge voltage of the auxiliary power source 92 achieves the target voltage Vt set in step S302. After step S305, the control unit 5 determines whether the start switch 70 is OFF, repeats the processing of steps S305 and S306 until the start switch 70 turns OFF, and maintains the charge voltage of the auxiliary power source 92 at the target voltage Vt. In this way, the control unit 5 operates to cause the charge/discharge circuit 3 to perform an operation such that the charge voltage of the auxiliary power source 92 achieves the target voltage Vt on condition that the start switch 70 of the vehicle is ON.

If it is determined in step S306 that the start switch 70 is OFF, the control unit 5, in step S307, stores the internal resistance and capacitance calculated in step S303 and the reference value Vb of the charge voltage calculated in step S304 in the storage unit 7.

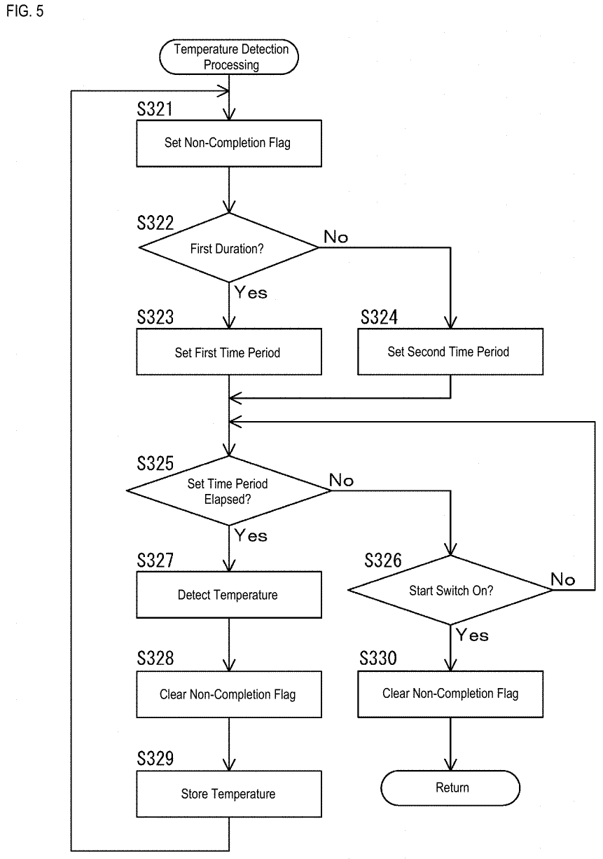

After step S307, the control unit 5, in step S308, performs temperature detection processing. As illustrated in FIG. 5, the control unit 5 sets the non-completion flag in step S321 of the temperature detection processing. After step S321, the control unit 5, in step S322, determines whether it is currently a first duration. In the present embodiment, a first duration and a second duration after the first duration are set. The first duration is, for example, a duration of 24 hours from when the condition for stopping the vehicle is established. The second duration is, for example, a duration from 24 hours after the condition for stopping the vehicle is established until when the condition for starting the vehicle is established.

The control unit 5 detects the temperature every first time period in the first duration, and detects the temperature every second time period in the second duration after the first duration, the second time period being longer than the first time period.

Specifically, if it is determined in step S322 that it is the first duration, the control unit 5, in step S323, sets the first time period. If it is determined that it is not the first duration (if it is determined that it is the second duration), the control unit 5, in step S324, sets the second time period. The first time period is a time period longer than 0 hours and shorter than the first duration, such as 1 hour, for example. The second time period is a time period longer than the first time period, such as 3 hours, for example. The control unit 5 sets the first time period or the second time period in step S323 or step S324 and operates a timer.

After step S323 or S324, the control unit 5, in step S325, determines whether the set time period set in step S323 or step S324 has elapsed. If it is determined that the set time period has not elapsed, the control unit 5, in step S326, determines whether the start switch 70 is ON. If it is determined that the start switch 70 is not ON, the control unit 5 returns the processing to step S325. In other words, the control unit 5 repeats the determinations of steps S325 and S326 until the set time period elapses or the start switch 70 turns ON.

If it is determined in step S325 that the set time period has elapsed, the control unit 5, in step S327, performs temperature detection. In step S327, the control unit 5 acquires a detection value from the temperature detection unit 50. After step S327, the control unit 5, in step S328, clears the non-completion flag. After step S328, the control unit 5, in step S329, stores the temperature detected in the immediately previous step S327.

After step S329, the control unit 5 returns the processing to step S321. In other words, in the first duration, the control unit 5 detects and stores the temperature every first time period. In the second duration after the first duration, the control unit 5 then detects and stores the temperature every second time period which is longer than the first time period.

If it is determined in step S326 that the start switch 70 is ON, the control unit 5, in step S330, clears the non-completion flag. The control unit 5 then ends the temperature detection processing of step 308 in FIG. 4 and returns the processing to step S301. The control unit 5 then reads out temperature information in step S301, sets the target voltage Vt in step S302 based on the read temperature information, and performs control such that the charge voltage of the auxiliary power source 92 achieves the target voltage Vt in step S305.

If it is determined that the auxiliary power source 92 has been removed while the vehicle is stopped, the control unit 5, in step S302, sets the target voltage Vt based only on the temperature detected before removal is determined. In the present embodiment, it is determined that the auxiliary power source 92 has been removed while the vehicle is stopped if it is determined in step S301A that the non-completion flag is set. In the present embodiment, the control of FIG. 4 is ended if it is determined that the auxiliary power source 92 has been removed, and thus temperature detection thereafter is not performed. According to this configuration, in the case where the auxiliary power source 92 has possibly been removed, the target voltage Vt can be set with the effect of temperature after removal eliminated.

In the present embodiment as described above, the control unit 5 detects the temperature every first time period in the first duration, after the start switch 70 turns OFF, and, in the second duration after the first duration, detects the temperature every second time period which is longer than the first time period. Thus, the temperature can be acquired every first time period at a relatively early stage after the start switch 70 turns OFF, and, after entering the second duration, the processing load of temperature detection can be reduced.

### Fourth Embodiment

The backup device 1 of a fourth embodiment differs from the third embodiment with regard to only the temperature detection processing in the above section “2. Control of Backup Device”, and is the same as the third embodiment with regard to the sections “1. Basic Configuration of Vehicular Backup Device”, “3. Detailed Description of Target Voltage Setting Method”, and “4. Operations at time of Power Loss”.

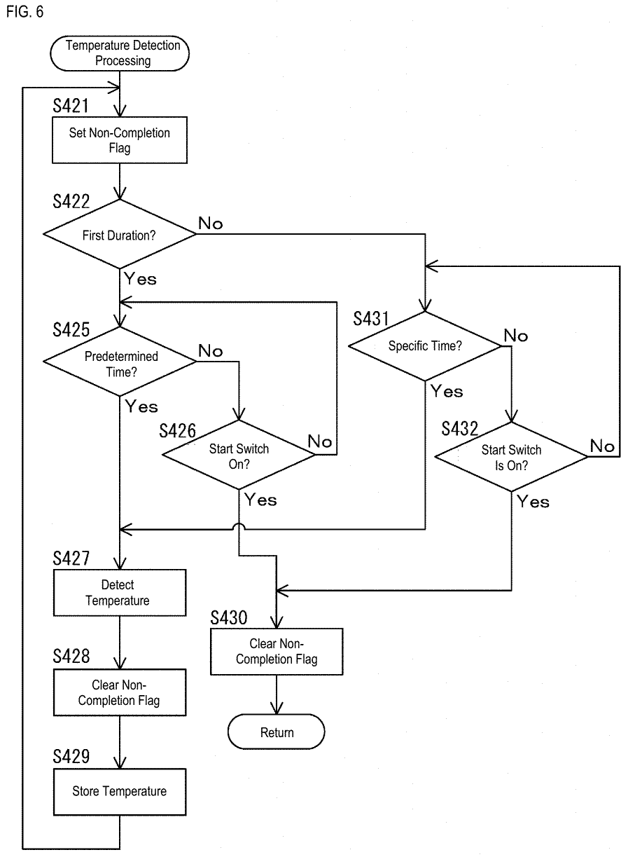

After step S307 in FIG. 4, the control unit 5 performs temperature detection processing illustrated in FIG. 6. As illustrated in FIG. 6, the control unit 5 sets the non-completion flag in step S421 of the temperature detection processing. After step S421, the control unit 5, in step S422, determines whether it is a first duration. In the present embodiment, a first duration and a second duration after the first duration are set, similarly to the third embodiment.

The control unit 5 detects the temperature at predetermined times determined in advance in the first duration, after the start switch 70 turns OFF, and, in the second duration after the first duration, detects the temperature only at a specific time, among the predetermined times, determined based on the temperatures detected in the first duration. In the present embodiment, the control unit 5 determines only the time at which the highest temperature is detected in the first duration to be the specific time.

If it is determined in step S422 that it is the first duration, the control unit 5, in step S425, determines whether a predetermined time determined in advance has arrived. The predetermined times may be times that are at a constant time interval such as 1 o'clock, 2 o'clock, 3 o'clock, 4 o'clock, and so on, or may be times that are not at a constant time interval such as 1 o'clock, 3 o'clock, 5 o'clock, 6 o'clock, and so on.

If it is determined that a predetermined time has not arrived, the control unit 5, in step S426, determines whether the start switch 70 is ON. If it is determined that the start switch 70 is not ON, the control unit 5 returns the processing to step S425. In other words, the control unit 5 repeats the determinations of steps S425 and S426 until a predetermined time arrives or the start switch 70 turns ON.

If it is determined in step S425 that a predetermined time has arrived, the control unit 5 performs temperature detection in step S427. In step S427, the control unit 5 acquires a detection value from the temperature detection unit 50. After step S427, the control unit 5, in step S428, clears the non-completion flag. After step S428, the control unit 5, in step S429, stores the temperature detected in the immediately previous step S427.

After step S429, the control unit 5 returns the processing to step S421. In other words, in the first duration, the control unit 5 detects and stores the temperature every time a predetermined time determined in advance arrives.

Upon entering the second duration, the control unit 5, in step S422, determines that it is not the first duration. In step S431, the control unit 5 then determines whether a specific time has arrived. If it is determined that the specific time has not arrived, the control unit 5, in step S432, determines whether the start switch 70 is ON. If it is determined that the start switch 70 is not ON, the control unit 5 returns the processing to step S431. In other words, the control unit 5 repeats the determinations of steps S431 and S432 until the specific time arrives or the start switch 70 turns ON.

If it is determined in step S431 that the specific time has arrived, the control unit 5 performs temperature detection in step S427. In step S427, the control unit 5 acquires a detection value from the temperature detection unit 50. After step S427, the control unit 5, in step S428, clears the non-completion flag. After step S428, the control unit 5, in step S429, stores the temperature detected in the immediately previous step S427.

After step S429, the control unit 5 returns the processing to step S421. In other words, in the second duration, the control unit 5 detects and stores the temperature every time the specific time arrives, the specific time being the time at which the highest temperature was detected among predetermined times.

If it is determined in step S426 or S432 that the start switch 70 is ON, the control unit 5, in step S430, clears the non-completion flag. The control unit 5 then ends the temperature detection processing of step 308 in FIG. 4 and returns the processing to step S301. The control unit 5 then reads out temperature information in step S301, sets the target voltage Vt in step S302 based on the read temperature information, and performs control such that the charge voltage of the auxiliary power source 92 achieves the target voltage Vt in step S305.

In the present embodiment as described above, the control unit 5 detects the temperature at predetermined times determined in advance in the first duration, after the start switch 70 turns OFF, and, in the second duration after the first duration, detects the temperature only at a specific time, among the predetermined times, determined based on the temperatures detected in the first duration. The temperatures of predetermined times can thus be acquired at a relatively early stage after the start switch 70 turns OFF, and, after entering the second duration, the processing load of temperature detection can be reduced, by performing temperature detection focusing on a specific time among the predetermined times.

In particular, in the present embodiment, the control unit 5 determines only the time at which the highest temperature is detected in the first duration to be the specific time. The temperature of a time that is highly likely to affect degradation of the auxiliary power source 92 can thus be efficiently detected in the second duration.

### Fifth Embodiment

The backup device 1 of a fifth embodiment differs from the fourth embodiment with regard to the method of determining the specific time, and is in common with the fourth embodiment in other respects.

The control unit 5 of the backup device 1 of the fifth embodiment determines only the time at which the highest temperature is detected and the time at which the lowest temperature is detected in the first duration to be the specific time. According to this configuration, the lowest temperature can also be detected in the second duration, while efficiently detecting the temperature of a time that is highly likely to affect degradation of the auxiliary power source 92.

### Sixth Embodiment

The backup device 1 of a sixth embodiment differs from the fourth embodiment with regard to the method of determining the specific time, and is in common with the fourth embodiment in other respects.

The control unit 5 of the backup device 1 of the sixth embodiment determines only times at which a temperature higher than a second threshold temperature is detected in the first duration to be the specific time. According to this configuration, the temperatures of times that are highly likely to affect degradation of the auxiliary power source 92 can be broadly detected in the second duration.

### Seventh Embodiment

The backup device 1 of a seventh embodiment differs from the sixth embodiment with regard to only the processing in the case where a temperature higher than the second threshold temperature is not detected in the first duration, and is in common with the sixth embodiment in other respects.

If a temperature higher than the second threshold temperature is detected in the first duration, the control unit 5 of the backup device 1 of the seventh embodiment determines only the time at which the temperature higher than the second threshold temperature is detected to be the specific time. The control unit 5 then detects the temperature at the specific time every first number of days in the second duration. If a temperature higher than the second threshold temperature is not detected in the first duration, the control unit 5 determines only the time at which the highest temperature is detected to be the specific time. The control unit 5 then detects the temperature at the specific time every second number of days in the second duration, the second number of days being longer than the first number of days. According to this configuration, even if a temperature exceeding the second threshold temperature is not detected in the first duration, the temperature information of the second duration can be reflected in the target voltage, by the temperature of the time at which the highest temperature is detected in the first duration being detected in the second duration.

Note that the first number of days is one day, for example, and the second number of days is three days, for example.

### Other Embodiments

The present disclosure is not limited to the embodiments illustrated in the above description and diagrams For example, the features of the embodiments described above and below can be combined in any way as long as there are no inconsistencies. Any of the features of the embodiments described above and below can also be omitted unless expressly stated as being essential. Furthermore, the embodiments described above may be modified as follows.

In the above embodiments, in step S4, the second target voltage value is calculated with a similar method to the method of calculating a second target voltage value in the invention described in JP 2018-068019A, and is taken as the reference value of the charge voltage, but the present disclosure is not limited to this example. For example, in step S4, another known method may be employed as the method of calculating the charge voltage (target voltage) of the auxiliary power source to be set during vehicle operation, and the charge voltage (target voltage) of the auxiliary power source calculated by the known method may be taken as the reference value of the charge voltage. For example, in step S4, the charge target voltage may be determined with a similar method to the method disclosed in JP 2018-170821A, and this charge target voltage may be taken as the reference value of the charge voltage. Alternatively, in step S4, a fixed value determined in advance may be taken as the reference value of the charge voltage.

In the above-described embodiments, a lead battery is used as the main power source 91 of the power system 100, but the main power source is not limited to this configuration. Another power source means (another known power storage means, power generation means, etc., such as a lithium-ion battery) may be used in place of or in combination with a lead battery as the main power source 91. The number of power source means constituting the main power source 91 is not limited to one, and the main power source 91 may be constituted by a plurality of power source means.

In the above-described embodiments, an electric double layer capacitor (EDLC) is used as the auxiliary power source 92 of the power system 100, but the auxiliary power source is not limited to this configuration. Another power storage means such as a lithium-ion battery, a lithium-ion capacitor or a nickel-metal hydride rechargeable battery may be used as the auxiliary power source 92. The number of power storage means constituting the auxiliary power source 92 is not limited to one, and the auxiliary power source 92 may be constituted by a plurality of power storage means.

In the above-described embodiments, an ignition switch is illustrated as the start switch, but the start switch is not limited to an ignition switch. In electric vehicles, fuel cell vehicles and the like, a switch that switches the vehicle to a start state in response to an operation by a user corresponds to the start switch.

In the above-described embodiments, the auxiliary power source 92 is part of the backup device 1, but the present disclosure is not limited to this example. The auxiliary power source 92 may be constituted as a separate device from the backup device 1. For example, in the power system 100, the auxiliary power source 92 may be provided as a unit separate from the unit constituting the backup device 1, while forming a circuit such as shown in FIG. 1.

In the third to seventh embodiments, the target voltage is set with the same method as the first embodiment, but a different method may be applied. For example, the target voltage setting method of the second embodiment may be applied.

Note that the embodiments disclosed herein are to be considered in all respects as illustrative and not restrictive. The scope of the present disclosure is not limited to the embodiment disclosed herein, and all changes that come within the scope defined by the claims or the range of equivalency of the claims are intended to be embraced therein.

1. A vehicular backup device for use in a vehicular power system that includes a main power source and an auxiliary power source that functions as a power supply source at least when power supply from the main power source is abnormal, and for controlling charging and discharging of the auxiliary power source, the backup device comprising:
a charge/discharge circuit configured to perform operations for charging and discharging the auxiliary power source;
a temperature detection unit configured to detect a temperature of the auxiliary power source or around the auxiliary power source; and
a control unit configured to cause the charge/discharge circuit to perform an operation such that a charge voltage of the auxiliary power source achieves a target voltage on condition that a start switch of a vehicle is ON,
wherein the control unit sets the target voltage based on the temperature detected by the temperature detection unit when the start switch is OFF.

2. The vehicular backup device according to claim 1, wherein the control unit sets the target voltage based on the temperature detected by the temperature detection unit after a given time period elapses while the start switch is maintained in the OFF state.

3. The vehicular backup device according to claim 1, wherein the control unit sets the target voltage based on the temperature detected by the temperature detection unit every predetermined time period when the start switch is maintained in the OFF state.

4. The vehicular backup device according to claim 1, wherein, in a case where the temperature detection unit detects temperatures of a plurality of durations when the start switch is OFF, the control unit calculates a representative value in accordance with a predetermined representative value calculation method based on the temperatures of the plurality of durations, and sets the target voltage to be higher as the representative value increases.

5. The vehicular backup device according to claim 1, wherein the control unit sets the target voltage based on temperatures exceeding a threshold temperature, among temperatures detected by the temperature detection unit when the start switch is OFF.

6. The vehicular backup device according to claim 1, wherein, in a case where the temperature detection unit detects temperatures of a plurality of durations when the start switch is OFF, the control unit calculates evaluation values obtained by multiplying the temperatures of the plurality of durations by respective weights in accordance with a predetermined weighting method for multiplying the temperature by a higher weight as the temperature increases, and sets the target voltage based on the plurality of evaluation values.

7. The vehicular backup device according to claim 1, wherein, after the start switch turns OFF, the control unit, in a first duration, detects the temperature every first time period, and, in a second duration after the first duration, detects the temperature every second time period which is longer than the first time period.

8. The vehicular backup device according to claim 1, wherein, after the start switch turns OFF, the control unit, in a first duration, detects the temperature at predetermined times determined in advance, and, in a second duration after the first duration, detects the temperature only at a specific time, among the predetermined times, determined based on the temperatures detected in the first duration.

9. The vehicular backup device according to claim 8, wherein the control unit determines only the time at which a highest temperature is detected in the first duration to be the specific time.

10. The vehicular backup device according to claim 8, wherein the control unit determines only the time at which a highest temperature is detected and the time at which a lowest temperature is detected in the first duration to be the specific time.

11. The vehicular backup device according to claim 8, wherein the control unit determines the time at which a temperature higher than a second threshold temperature is detected in the first duration to be the specific time.

12. The vehicular backup device according to claim 11, wherein the control unit, in a case where a temperature higher than the second threshold temperature is detected in the first duration, determines only the time at which the temperature higher than the second threshold temperature is detected to be the specific time, and detects the temperature at the specific time every first number of days in the second duration, and, in a case where a temperature higher than the second threshold temperature is not detected in the first duration, determines only the time at which a highest temperature is detected to be the specific time, and detects the temperature at the specific time every second number of days in the second duration, the second number of days being longer than the first number of days.

13. The vehicular backup device according to claim 1, wherein, in a case where it is determined that the auxiliary power source has been removed, the control unit sets the target voltage based only on the temperature detected before removal is determined.

14. The vehicular backup device according to claim 1, wherein, in a case where it is determined that the auxiliary power source has been removed, the control unit outputs a notification that the auxiliary power source has been removed.
